(19) United States
(12) Patent Application Publication
(10) Pub. No.: US 2026/0133984 A1
(43) Pub. Date: May 14, 2026

(54) METHODS AND DEVICES FOR QUERY SPLITTING BASED ON DEVICE DISPLAY DIMENSIONS

(71) Applicant: Shopify Inc., Ottawa (CA)

(72) Inventor: Andrew MUSGRAVE, Ottawa (CA)

(21) Appl. No.: 18/942,934

(22) Filed: Nov. 11, 2024

(51) Int. Cl. G06F 16/248

(52) U.S. Cl. CPC G06F 16/248

(57) ABSTRACT

Methods and devices for automatic optimization of a large data retrieval request are described. A viewport size for displaying data records on a display associated with the client device is obtained. Responsive to a user query for a plurality of data records, a first request, a second request and a third request are sent to a data server for retrieving a first subset of data records, a set of partial data records, and at least a remainder of the plurality of data records. Responsive to receiving at least the first subset of data records and the set of partial data records, providing the first subset of data records to be viewable in a viewport via the display associated with the client device, and responsive to receiving at least the remainder of the plurality of data records, providing the remainder of the plurality of data records for output via the display.

### FIELD

The present disclosure relates to data retrieval requests for large databases, and, more particularly, to data query optimization for large data retrieval requests, and, yet more particularly, to query splitting based on device display dimensions.

### BACKGROUND

Databases store large volumes of data. Data can be requested by querying the database. In addition to retrieving data, a query may also perform calculations, filter the data, or manipulate the data stored in the database, for example, by aggregating, creating, changing, or deleting data records in the database.

A database may be a relational database. In a relational database, data points may be related to each other and are stored in rows and columns to form tables.

### SUMMARY

Database queries on large database tables or lists can be slow to load, leading to page time-outs, communication bottlenecks, overall decrease in system performance and/or poor user experience. For example, when a webpage outputting a large table or list (e.g., associated with a query) is loaded, typically all data records must be loaded. While a query may be tuned or optimized to improve data retrieval, delays in data loading may still depend on the volume of data to be loaded and the limits of hardware processing capabilities.

In various examples, the present disclosure provides a technical solution for optimizing data retrieval requests that addresses at least some of the above drawbacks. A client device may be associated with a display having physical display dimensions (e.g., a physical screen size), which limits the amount of information that can be output to the display without requiring a user to scroll, for example. In various examples, the present disclosure describes methods and devices for automatically optimizing a large data retrieval request at a client device (e.g., associated with a query to a database), by splitting the retrieval request into multiple retrieval requests based on a viewport size of a display of the client device. More specifically, a viewport size for displaying data records on a display associated with the client device is determined. Responsive to a user query for a plurality of data records, a first request is sent to a data server for retrieving a first subset of data records, based on the user query and the viewport size, a second request is sent to the data server for retrieving a set of partial data records, based on the user query and one or more critical information fields of the plurality of data records, and a third request is sent to the data server for retrieving at least a remainder of the plurality of data records, based on the user query. Responsive to receiving at least the first subset of data records and the set of partial data records, the first subset of data records is provided to be viewable in a viewport via the display associated with the client device, and responsive to receiving at least the remainder of the plurality of data records, the remainder of the plurality of data records is provided for output via the display of the client device.

In providing a method that splits a large data retrieval request into multiple retrieval requests based on a viewport size of a display of the client device, the technical solution recognizes that, when a page outputting a large table or list (e.g., associated with a query) is loaded, only a first subset of the data records will be visible to the user on the display. For example, based on the dimensions of a physical display associated with the client device, the first subset of data records may represent 10-15 rows (e.g., depending on the row height, among other possible viewing parameters). The user may then scroll down the page to view the remaining data records. In this regard, the number of data records that are requested (e.g., the number of rows in the data table or list being fetched) in a first subset of data records may represent a quantity of data records that, when output to the display associated with the client device, are viewable in the viewport without scrolling. More preferably, the number of data records that are requested in the first subset of data records may represent the maximum number of data records that are viewable in the viewport without scrolling. In this regard, the initial loading time is reduced commensurate with the data size of the first subset of data records.

Advantageously, examples of the disclosed solution may make efficient use of computational and other resources (e.g., processing power, memory, computing time, etc.) associated with large data requests. The multiple retrieval requests are further configured to retrieve a subset of data representing the critical fields for all data records associated with the query as well as the remaining data records (e.g., those not included in the first subset of data records, or all records associated with the data query including the first subset of data records, among other possibilities). In this regard, the subsequently received data records can be loaded asynchronously, thereby reducing the latency to render the page, improving overall system responsiveness and improving user experience.

Examples of the disclosed solution may provide a technical advantage of improving processing times and reducing delays in data loading that may negatively impact overall system responsiveness, cause page timeouts, and/or be perceived negatively by a user. For example, in some simulations the disclosed solution may generally reduce the time to render a page containing data from large queries (e.g., query for over 100 data records) by at least 50% over conventional approaches. In an example simulation involving a complex query of 250 data records, loading the page containing returned data records using conventional approaches can take a significant amount of time (e.g., 3 seconds), whereas the disclosed solution may reduce the page loading time to ˜500 ms.

Advantageously, the technical solution is agnostic to a database query language. In this regard, the technical solution may be implemented using a range of database query languages, such as graphQL, REST, among other possibilities.

In some examples, the present disclosure describes a computer-implemented method. The method includes a number of steps, including: obtaining a viewport size for displaying data records on a display associated with a client device; responsive to a user query for a plurality of data records, sending, to a data server: a first request for retrieving a first subset of data records, based on the user query and the viewport size; a second request for retrieving a set of partial data records, based on the user query and one or more critical information fields of the plurality of data records; and a third request for retrieving at least a remainder of the plurality of data records, based on the user query; responsive to receiving at least the first subset of data records and the set of partial data records, providing the first subset of data records to be viewable in a viewport via the display associated with the client device; and responsive to receiving at least the remainder of the plurality of data records, providing the remainder of the plurality of data records for output via the display associated with the client device.

In an example of the preceding example aspect of the method, wherein the third request is a request for retrieving a second subset of data records that is the remainder of the plurality of data records excluding the first subset of data records.

In an example of a preceding example aspect of the method, wherein the third request is a request for retrieving the plurality of data records including the first subset of data records.

In an example of a preceding example aspect of the method, further comprising: prior to sending the first request: determining a number of rows of the plurality of data records that are viewable in the viewport based on the viewport size and a row height; and storing the determined number of rows in a local cache.

In an example of a preceding example aspect of the method, wherein the viewport is provided within an application, and the viewport size is obtained for a first page when the first page is rendered in the application.

In an example of a preceding example aspect of the method, wherein obtaining the viewport size comprises: determining the viewport size based on viewport information, wherein the viewport information comprises at least one of: dimensions of the display of the client device; orientation of the display; dimensions of a window of the application; display settings of the application or the client device; or accessibility settings of the application or the client device.

In an example of a preceding example aspect of the method, wherein obtaining the viewport size comprises determining the viewport size based on viewport information comprising dimensions of one or more user interface (UI) elements of the application.

In an example of a preceding example aspect of the method, wherein the viewport size includes a viewport width and a viewport height.

In an example of a preceding example aspect of the method, wherein the first request, the second request and the third request all include a common timestamp.

In an example of a preceding example aspect of the method, wherein the third request is sent after receiving at least the set of partial data records, and wherein the third request is generated based on information in the one or more critical information fields retrieved in the set of partial data records.

In some examples, the present disclosure describes a non-transitory computer-readable medium storing instructions that, when executed by a processing unit of a computing system, cause the computing system to: obtain a viewport size for displaying data records on a display associated with a client device; responsive to a user query for a plurality of data records, send, to a data server: a first request for retrieving a first subset of data records, based on the user query and the viewport size; a second request for retrieving a set of partial data records, based on the user query and one or more critical information fields of the plurality of data records; and a third request for retrieving at least a remainder of the plurality of data records, based on the user query; responsive to receiving at least the first subset of data records and the set of partial data records, provide the first subset of data records to be viewable in a viewport via the display associated with the client device; and responsive to receiving at least the remainder of the plurality of data records, provide the remainder of the plurality of data records for output via the display associated with the client device.

In an example of the preceding example aspect of the computer-readable medium, wherein the third request is a request for retrieving a second subset of data records that is the remainder of the plurality of data records excluding the first subset of data records.

In an example of a preceding example aspect of the computer-readable medium, wherein the third request is a request for retrieving the plurality of data records including the first subset of data records.

In an example of a preceding example aspect of the computer-readable medium, wherein the instructions, when executed, further cause the computing system to: prior to sending the first request: determine a number of rows of the plurality of data records that are viewable in the viewport based on the viewport size and a row height; and store the determined number of rows in a local cache.

In an example of a preceding example aspect of the computer-readable medium, wherein the viewport is provided within an application, and the viewport size is obtained for a first page when the first page is rendered in the application.

In an example of a preceding example aspect of the computer-readable medium, wherein the instructions, when executed to obtain the viewport size, further cause the computing system to: determine the viewport size based on viewport information, wherein the viewport information comprises at least one of: dimensions of the display of the client device; orientation of the display; dimensions of a window of the application; display settings of the application or the client device; or accessibility settings of the application or the client device.

In an example of a preceding example aspect of the computer-readable medium, wherein the instructions, when executed to obtain the viewport size, further cause the computing system to: determine the viewport size based on viewport information comprising dimensions of one or more user interface (UI) elements of the application.

In an example of a preceding example aspect of the computer-readable medium, wherein the viewport size includes a viewport width and a viewport height.

In an example of a preceding example aspect of the computer-readable medium, wherein the first request, the second request and the third request all include a common timestamp.

In some examples, the present disclosure describes an apparatus comprising: a processing unit communicatively coupled to a display device, the processing unit being configured to: obtain a viewport size for displaying data records on the display device; responsive to a user query for a plurality of data records, send, to a data server: a first request for retrieving a first subset of data records, based on the user query and the viewport size; a second request for retrieving a set of partial data records, based on the user query and one or more critical information fields of the plurality of data records; and a third request for retrieving at least a remainder of the plurality of data records, based on the user query; responsive to receiving at least the first subset of data records and the set of partial data records, provide the first subset of data records to be viewable in a viewport via the display device; and responsive to receiving at least the remainder of the plurality of data records, provide the remainder of the plurality of data records for output via the display device.

### BRIEF DESCRIPTION OF THE DRAWINGS

Reference will now be made, by way of example, to the accompanying drawings which show example embodiments of the present application, and in which:

FIG. 1 is a block diagram illustrating an exemplary simplified system in which exemplary embodiments of the present disclosure may be implemented;

FIG. 2 is a block diagram of an example computing system, which may be used to implement examples of the present disclosure;

FIG. 3 shows a block diagram of an example architecture for a query splitting module, in accordance with example embodiments of the present disclosure;

FIG. 4 is a schematic representation of a graphical user interface (GUI) of a web application presented on a display, suitable for implementation of examples described herein;

FIG. 5A is an example first request for retrieving a first subset of data records, in accordance with example embodiments of the present disclosure;

FIG. 5B is an example first request for retrieving a first subset of data records, in accordance with example embodiments of the present disclosure;

FIG. 5C is an example first request for retrieving a first subset of data records, in accordance with example embodiments of the present disclosure; and

FIG. 6 is a flowchart illustrating an example computer-implemented method for optimizing data retrieval requests, in accordance with examples of the present disclosure.

Similar reference numerals may have been used in different figures to denote similar components.

### DETAILED DESCRIPTION

In various examples, methods and devices for the automatic optimization of data retrieval requests are described. A viewport size for displaying data records on a display associated with the client device is obtained, and responsive to a user query for a plurality of data records, a first request, a second request and a third request are sent to a data server for retrieving a first subset of data records, a set of partial data records, and at least a remainder of the plurality of data records. Responsive to receiving at least the first subset of data records and the set of partial data records, the first subset of data records is provided to be viewable in a viewport via the display associated with the client device. Responsive to receiving at least the remainder of the plurality of data records, the remainder of the plurality of data records is provided for output via the display of the client device. The disclosed methods and systems effectively split the retrieval request into multiple retrieval requests based on a viewport size of a display of the client device, thereby reducing the latency to render the page and improving overall system responsiveness.

Examples of the disclosed solution may improve processing times and reduce delays in data loading that may negatively impact overall system responsiveness, cause page timeouts, and/or be perceived negatively by a user. By splitting a large data retrieval request into multiple retrieval requests based on a viewport size of a display of the client device, an initial subset of data records may be loaded, where the initial subset of data records represents a quantity of data records that, when output to the display associated with the client device, are viewable in the viewport without scrolling, without changing the size of the displayed rows, without resizing or removing other UI elements of the viewport, etc. In this regard, the initial data loading time is reduced commensurate with the data size of the first subset of data records, and the subsequently received data records can then be loaded asynchronously, thereby reducing latency and improving user experience.

To assist in understanding the present disclosure, the following describes some concepts relevant to relational database management along with some relevant terminology that may be related to examples disclosed herein.

A relational database may store large amounts of data in tables consisting of rows and columns, where each row in a table may represent a specific entity (e.g., a data record) and each column in the table may represent an attribute (e.g., a field or record type) of the entity. Database queries may be used to filter or retrieve data from multiple tables into a single table or list, among other formats (e.g., such as graphs, or images, etc.). Database queries may be used to quickly find or summarize information stored in the database. Database queries may also be executed to take actions on the data stored in the database, for example, to read the data, perform calculations on the data, or manipulate the data, for example, by aggregating, ordering, summarizing, creating, changing, updating, or deleting data records in the database, among other possibilities.

In the present disclosure, a “display size” of a display associated with an electronic device can mean: the physical size of an area of a display or a screen of an electronic device on which content can be output or displayed. For example, the display size may be described by a length of its diagonal, for example, measured in inches. In the present disclosure, a “display resolution” can mean the physical pixel dimensions of the display, for example, commonly represented as pixel width×pixel height.

In the present disclosure, a “device pixel ratio (DPR)” or a “CSS pixel ratio” can mean: the ratio between a physical pixel density (or resolution) of a display associated with an electronic device and a logical pixel density (or resolution) for the display. Put another way, the DPR is the number of physical pixels per logical pixel for a display. In examples, “physical pixels” may represent the actual hardware pixels of a display, for example, the squares of colored light that produce an image on a device display, while logical pixels (or CSS pixels or software pixels) may represent a unit of measure in CSS, for example, length.

In the present disclosure, “viewport” can mean: a region of a display within which a software application (e.g., a web browser) may output content to the display. For example, the viewport may represent a visible area (e.g., defined by a length and a width in CSS pixels) of the display where a web page is output, excluding UI elements associated with the application such as menu bars, scroll bars, etc.

In the present disclosure, a “viewport size” can mean: dimensions of the viewport (e.g., in CSS pixels) that define a width and a height of the viewport. In some examples, the viewport size may be smaller than the display size, and may depend on the size or type of electronic device. For example, on a desktop device, the viewport size may represent the size of an application window size (e.g., such as a web browser), excluding the interface associated with the application (e.g., UI elements, operating system elements, etc.), or on another device (e.g., such as a mobile device) the viewport may generally match the size of the display.

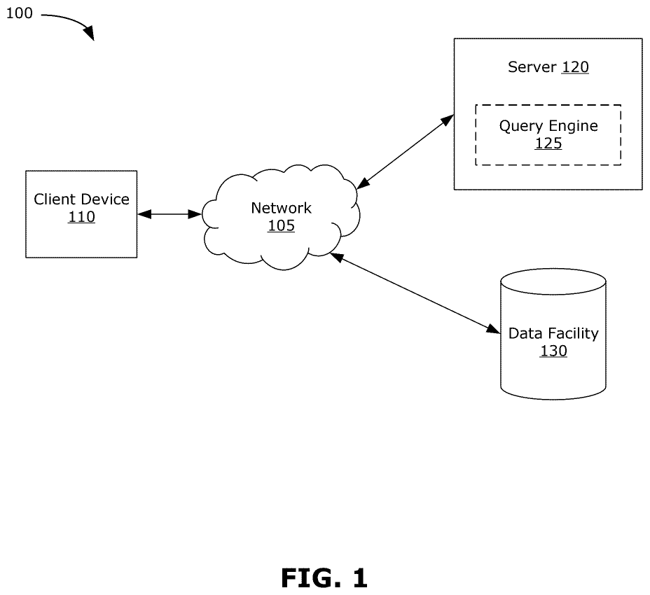

FIG. 1 is a block diagram illustrating an exemplary simplified system 100 in which exemplary embodiments of the present disclosure may be implemented. The system 100 has been simplified in this example for ease of understanding. Generally, there may be more entities and components in the system 100 than that shown in FIG. 1. The system 100 may be an integrated system for requesting data from a database. The system 100 may include a data communications network 105. The data communications network 105 may be any form of data communications network (e.g., an intranet, the Internet, a P2P network, a WAN and/or a LAN, among other possibilities). The system 100 may further include one or more client devices 110, a server 120 and a data facility 130. Although the server 120 and the data facility 130 are shown as separate components, it is understood that the server 120 and the data facility 130 could be embodied in a single component, such as a cloud environment, among other possibilities.

In examples, a user may interact with the system 100 via the client device 110, for example, the client device 110 may connect to the network 105 in order to communicate with the server 120 to request access to a service provided by a server 120 and to cause the client device 110 to provide an output, as described herein. The client device 110 may be associated with a display (not shown), for example, for providing output to a user on the display. In examples, the client device 110 can be a desktop computer, a laptop computer, a mobile communication device (such as a smart phone or a tablet), a wearable device (such as a smart watch or VR headset), or any other suitable computing device that can perform the functionality described herein.

The term “server”, as used herein, is not intended to be limited to a single hardware device. For example, the server 120 may include a server device, a distributed computing system, a virtual machine running on an infrastructure of a datacenter, or infrastructure (e.g., virtual machines) provided as a service by a cloud service provider, among other possibilities. Generally, the server 120 may be implemented using any suitable combination of hardware and software, and may be embodied as a single physical apparatus (e.g., a server device) or as a plurality of physical apparatuses (e.g., multiple machines sharing pooled resources such as in the case of a cloud service provider). The term “resources”, as used herein, can refer to hardware or software elements, for example, physical hardware infrastructure or virtual infrastructure. By way of example, resource capacity may be expressed in terms of processing power or bandwidth, memory, storage space, computing time, etc.

In examples, the server 120 may be a data server and may include a query engine 125, for example, for executing one or more queries for requesting data (e.g., data records) from the data facility 130. In examples, the data facility may be a database or a distributed storage or data repository, for example, a cloud-based storage or data repository. In examples, the data facility 130 may store large volumes of data (e.g., current or historical data), for example, stored in a relational database management system (RDBMS), such as an SQL server, among other possibilities, for example, providing unique data relationships through schemas and tables.

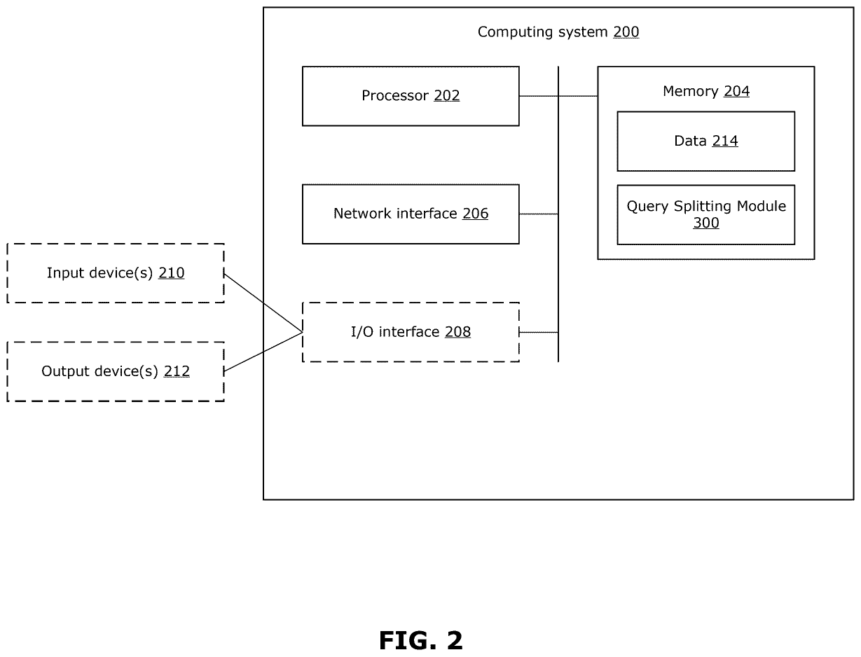

FIG. 2 illustrates an example computing system 200, which may be used to implement examples of the present disclosure. For example, the computing system 200 may be used to implement processes of the query splitting module 300, for example, for generating multiple data requests for providing to a data server (e.g., server 120), as disclosed herein.

The example computing system 200 includes at least one processing unit and at least one physical memory 204. The processing unit may be a hardware processor 202 (simply referred to as processor 202). The processor 202 may be, for example, a central processing unit (CPU), a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 204 may include a volatile or non-volatile memory (e.g., a flash memory, a random access memory (RAM), and/or a read-only memory (ROM)). The memory 204 may store instructions for execution by the processor 202, to the computing system 200 to carry out examples of the methods, functionalities, systems and modules disclosed herein.

The computing system 200 may also include at least one network interface 206 for wired and/or wireless communications with an external system and/or network (e.g., an intranet, the Internet, a P2P network, a WAN and/or a LAN). A network interface may enable the computing system 200 to carry out communications (e.g., wireless communications) with systems external to the computing system 200.

The computing system 200 may optionally include at least one input/output (I/O) interface 208, which may interface with optional input device(s) 210 and/or optional output device(s) 212. Input device(s) 210 may include, for example, buttons, a microphone, a touchscreen, a keyboard, etc. Output device(s) 212 may include, for example, a display, a speaker, etc. In this example, optional input device(s) 210 and optional output device(s) 212 are shown external to the computing system 200. In other examples, one or more of the input device(s) 210 and/or output device(s) 212 may be an internal component of the computing system 200.

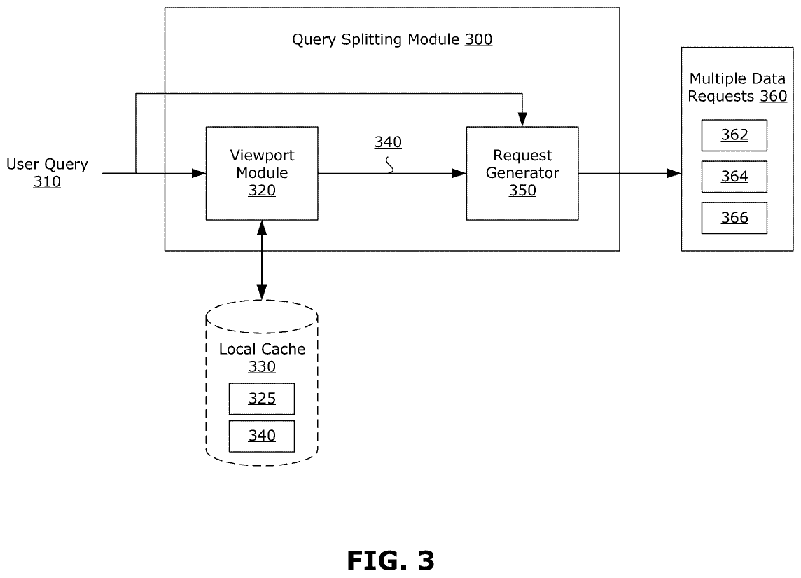

In the example of FIG. 2, the computing system 200 may store in the memory 204 computer-executable instructions, which may be executed by a processing unit such as the processor 202, to implement one or more embodiments disclosed herein. For example, the memory 204 may store instructions for executing a query splitting module 300 (e.g., described with respect to FIG. 3 below), which may cause the computing system 200 to carry out methods disclosed herein. The memory 204 may include other software instructions, such as for implementing an operating system and other applications/functions. The memory 204 may also include data 214, such as data stored in a local cache, etc.

In some examples, the computing system 200 may also include one or more electronic storage units (not shown), such as a solid state drive, a hard disk drive, a magnetic disk drive and/or an optical disk drive. In some examples, one or more data sets and/or modules may be provided by an external memory (e.g., an external drive in wired or wireless communication with the computing system 200) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The components of the computing system 200 may communicate with each other via a bus, for example.

As will be discussed further below, the present disclosure describes an example query spitting module 300 that enables the splitting of a user query requesting a plurality of data records into multiple data requests, based on a viewport size associated with a client device 110.

FIG. 3 shows a block diagram of an example architecture for the query splitting module 300, in accordance with examples of the present disclosure. The query splitting module 300 may be a software that is implemented in the computing system 200 of FIG. 2, in which the processor 202 is configured to execute instructions of the query splitting module 300 stored in the memory 204. The query splitting module 300 may receive a user query 310 (for example, requesting a plurality of data records) and may generate multiple data requests for providing to a data server. In examples, the query splitting module 300 may include a viewport module 320 and a request generator 350.

In examples, the user query 310 may be received by the query splitting module 300, for example, via a web user interface (UI) of a web application, or an application interface of a software application running on the client device 110, among other possibilities. In examples, the web application or the software application may enable user interaction with a database (e.g., such as a database of data facility 130), for example, for storing data in the database and retrieving data from the database. In examples, the user query 310 requesting a plurality of data records may be received as a selection of one or more attributes corresponding to a desired number of data records (or a desired number of data records corresponding to a particular timestamp), among other possibilities. For example, a user query 310 corresponding to the 50 most recent orders or transactions (e.g., where most recent orders or transactions are determined as having been completed prior to a particular timestamp) for an online entity may specify attributes such as order ID, customer name, customer email, shipping label status, order fulfillment status etc. In examples, the user query 310 may be received as a selection of the one or more attributes via a webpage of the web application or via an application window of the software application, or the user query 310 may be received via a microphone of computing system 200, for example, as an audio input, or the user query 310 may be received in another format.

In examples, the viewport module 320 may receive the user query 310 and may determine, based on a viewport size 325 that is associated with a display of the client device 110, how many data records (e.g., rows) may be viewable in the viewport once the plurality of data records associated with the user query 310 have been retrieved. In examples, the viewport module 320 may query a local cache 330 of the client device 110 to determine if a number of viewable rows 340 (e.g., for the particular web application or the software application) has been previously determined and stored in the local cache 330. In examples, responsive to determining that the number of viewable rows 340 was previously determined and stored in the local cache 330, the viewport module 320 may obtain the number of viewable rows 340 from the local cache 330.

Responsive to determining that the number of viewable rows 340 is not stored in the local cache 330, the viewport module 320 may query the local cache 330 to determine if a viewport size 325 (e.g., for the particular web application or the software application) has been previously obtained and stored in the local cache 330. In examples, responsive to determining that the viewport size 325 was previously stored in the local cache 330, the viewport module 320 may obtain the viewport size 325 from the local cache 330 and may determine the number of viewable rows 340 based on the viewport size 325. In examples, a viewport size 325 may be represented by CSS pixel dimensions, such as a viewport width and a viewport height. For example, the viewport module 320 may determine a row height of a table or list in the web application or the software application (e.g., associated with displaying the plurality of data records in a table or list of retrieved data records). In examples, the viewport module 320 may then determine how many rows of the table or list may be viewable in the viewport 325, for example, without requiring a user to scroll the UI of the web application or the software application. Using the viewport size 325 and the row height, the viewport module 320 may determine the number of viewable rows 340 and may store the number of viewable rows 340 in the local cache 330.

Responsive to determining that the viewport size 325 is not stored in the local cache 330, the viewport module 320 may obtain the viewport size 325. In examples, the viewport size 325 may be determined at the client device 110, based on one or more parameters of the display associated with the client device 110 and/or applications running on the client device 110. In some examples, the viewport size 325 may be automatically determined by the web application or the software application the first time a web page is rendered in the web application, or the first time an application window is opened in the software application. In other examples, the viewport module 320 may obtain viewport information from the web application or the software application, or from the system settings associated with the client device 110, such as the dimensions of the display associated with the client device 110, the orientation of the display, the dimensions of a window of the web application (e.g., a browser window) or the software application (e.g., an application window), display settings of the web application, the software application or the client device 110 (e.g., physical resolution, pixel resolution, DPR, zoom settings, etc.), accessibility settings of the web application, the software application or the client device 110, or dimensions of one or more user interface (UI) elements of the web application or the software application, or operating system elements, etc. In examples, UI elements may include menus and/or menu bars, toolbars, navigation bars, scroll bars, filter bars, headers, footers, frame, buttons, drop-downs, input fields, notifications, on-screen keyboards, calls to action (CTA), among other possibilities.

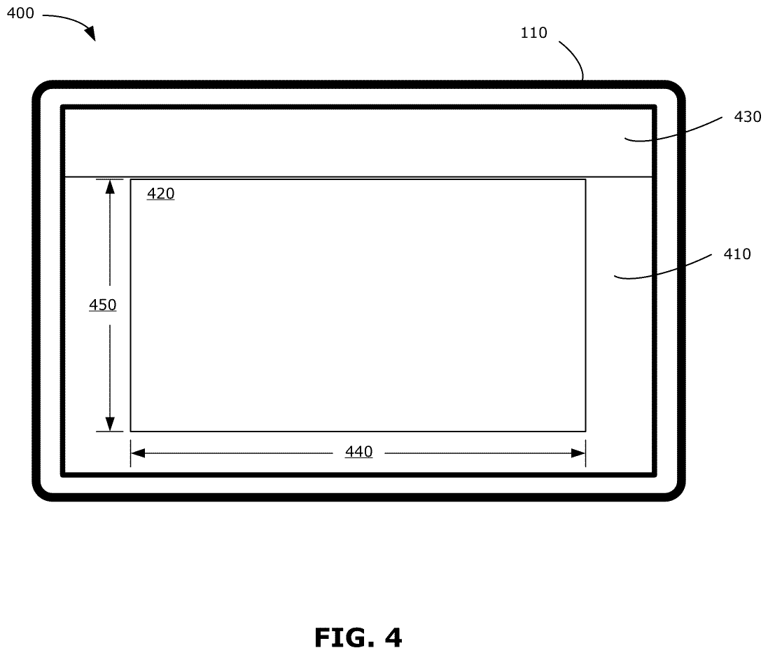

FIG. 4 is a schematic representation of a graphical user interface (GUI) 400 of a web application presented on a display associated with the client device 110, suitable for implementation of examples described herein. In the illustrated example of FIG. 4, an application window 410 corresponding to a web application is active in the GUI 400 and a viewport 420 is visible within the application window 410.

For the purposes of illustration, the application window 410 includes a UI element 430 along the top of the application window 410, for example, representing a navigation bar of a web browser, among other possibilities. Although only one UI element 430 is shown in the application window 410, it is understood that other UI elements may be included, for example, along the bottom or sides of the application window 410. In examples, the viewport 420 is positioned within the application window 410, where the viewport size 325 is described by a viewport width 440 and a viewport height 450. In examples, the viewport size 325 may be restricted by one or more UI elements 430. For example, the viewport size 325 may be determined based on the dimensions of the application window 410 (e.g., a browser size), excluding the one or more application UI elements 430.

Returning to FIG. 3, in some embodiments, for example, the viewport module 320 may determine the viewport size 325 based on the viewport information. For example, the viewport module 320 may determine that the viewport size 325 is equal to the dimensions of an application window size (e.g., a browser size) excluding the one or more application UI elements or operating system elements, among other possibilities. In examples, the viewport module 320 may then determine the number of viewable rows 340, based on the viewport size 325, and may store the viewport size 325 and the number of viewable rows 340 in the local cache 330. In examples, the stored viewport size 325 and/or the number of viewable rows 340 may be mapped to the display associated with the client device 110 for future retrieval. In examples, the viewport size may be updated responsive to user interactions with the client device 110, for example, as the display associated with the client device 110 is rotated (e.g., from portrait to landscape) or as a user drags an application window from one display to another display, for example, in a dual-monitor configuration, among other possibilities.

In examples, prior to receiving the user query 310, the web application or the software application may automatically obtain the viewport size 325, for example, the first time the user loads a first page of the web application, causing the first page to be rendered in the application. In examples, the web application or the software application may automatically store the viewport size 325 in the local cache 330, and the stored viewport size 325 may be usable for re-rendering the first page in the web application, for example, responsive to receiving a further request for a plurality of data records.

In some embodiments, for example, responsive to rendering a second page in the web application, the viewport module 320 may determine whether a corresponding viewport size 325 for the second page is stored in a local cache 330, and responsive to determining that the corresponding viewport size 325 for the second page is not stored in the local cache 330, the viewport module 320 may determine a respective viewport size 325 for the second page and store the viewport size 325 for the second page in the local cache 330.

In examples, the request generator 350 may receive the number of viewable rows 340 and the user query 310 and may generate multiple data requests 360 for sending to the data server. In examples, the request generator 350 may generate the multiple data requests 360 using various query languages, for example, graph query language (GraphQL), among others, or using a Representational State Transfer (“REST”) API, among other possibilities. For example, a first request 362 for retrieving a first subset of data records may be generated, based on the user query 310 and the number of viewable rows 340 of data records that may be visible in the viewport. For example, a parameter may be passed into the first request to retrieve the first n data records of only the first n rows that will be visible within the viewport, for example, without requiring a user to scroll.

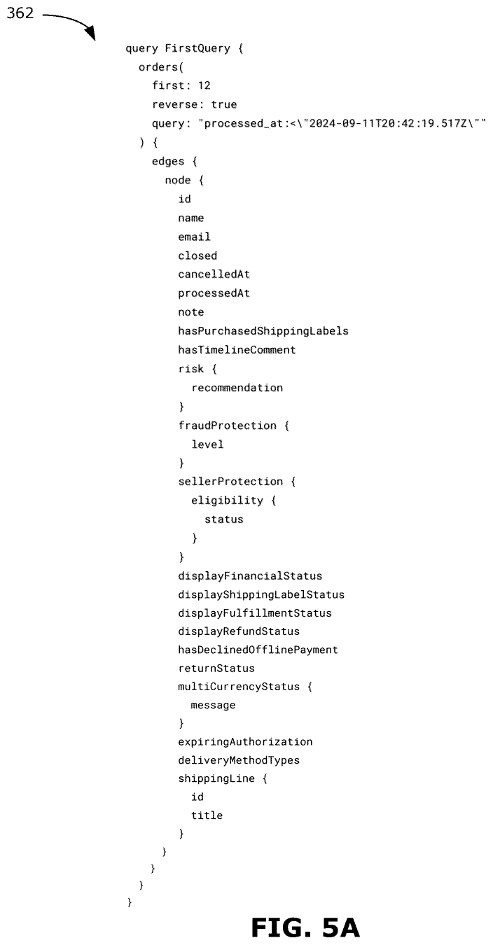

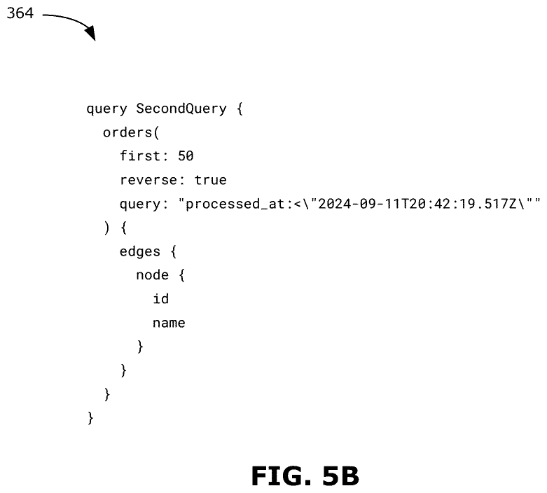

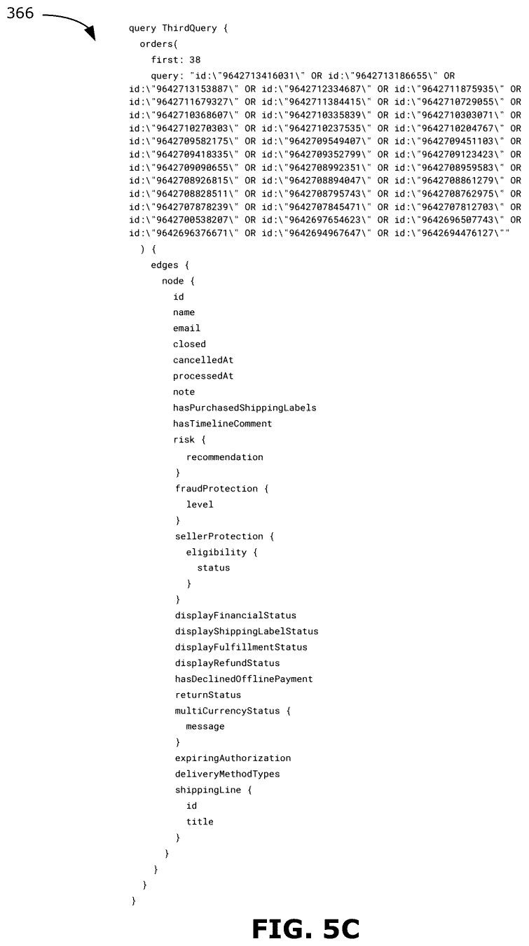

An example first request 362 written in GraphQL is provided in FIG. 5A. In examples, a user query 310 for retrieving the 50 most recent orders or transactions may be received by the request generator 350, along with a number of viewable rows 340 equal to 12 rows, and the request generator 350 may configure the first request 362 to request a first subset of 12 data records. In examples, a timestamp may be specified in the first request 362, among other attributes corresponding to the first subset of data records.

In some embodiments, for example, in parallel with (or responsive to) the first request 362, a second request 364 for retrieving a set of partial data records may be generated by the request generator 350, based on the user query 310 and one or more critical information fields of the plurality of data records. In examples, the second request 364 may be configured to include only critical fields of data (e.g., predetermined columns or information fields, such as record ID, name etc.) for each data record returned for the user query (e.g., for all rows of the returned data table or list). In examples, ensuring that all data associated with the critical fields are returned ensures that basic functionality of a web page is maintained (e.g., an ability to perform bulk actions on lists of data records), when loading a portion of the plurality of data records requested in the user query 310, for example, the portion of data records associated with the first request 362 and the second request 364. An example second request 364 written in GraphQL is provided in FIG. 5B, for example, showing that the second request 364 is configured to request critical fields of data (e.g., the ID and name fields) for the 50 most recent orders or transactions specified in the user query 310.

In examples, a third request 366 may be generated by the request generator 350 for retrieving at least a remainder of the plurality of data records based on the data query 310. In some embodiments, for example, the third request 366 may retrieve a second subset of data records that is the remainder of the plurality of data records, excluding the first subset of data records, for example, from row n+1 until the end of the data table or list associated with the user query 310. An example third request 366 written in GraphQL is provided in FIG. 5C, for example, where data records for the remaining 38 records of the 50 most recent orders or transactions specified in the user query 310 (e.g., excluding the first 12 data records associated with the first request 362) are requested. In other embodiments, for example, the third request 366 may retrieve the plurality of data records including the first subset of data records, among other possibilities.

In some embodiments, for example, depending on the API used, the request generator 350 may require information returned from the second request 364 to generate the third request 366. In other embodiments, the third request 366 may be generated by the request generator 350 and dispatched in parallel with the first request 362 and the second request 364. Thus, in some embodiments the first, second and third requests 362, 364, 366 may be generated and sent in any order and/or in parallel.

In some embodiments, for example, it is reasonable to expect that the first subset of data records corresponding to the first request 362 and the set of partial data records corresponding to the second request 364 may be returned more quickly than the remainder of the plurality of data records corresponding to the third request 366. Responsive to receiving at least the first subset of data records (e.g., the first n rows of data records in response to the first request 362) and the set of partial data records (e.g., including the critical field information for all rows of data records associated with the user query 310, in response to the second request 364) the application may render the web page to display a data table or list including the first n rows of returned data records viewable in the viewport, for example, via the display associated with the client device 110. In this regard, the first subset of data records and the set of partial data records may be provided for output via the display associated with the client device 110. In examples, prior to receiving at least the remainder of the plurality of data records, the application may also render placeholders for the remaining data records (e.g., corresponding to the third request 366), for example, based on the critical field information. In this regard, the initial data loading time is reduced commensurate with the data size of the first subset of data records, without compromising page functionality. In some embodiments, for example, prior to receiving at least the first subset of data records and the set of partial data records, there may be additional operations performed on some or all of the first subset of data records and the set of partial data records before the first subset of data records and the set of partial data records are received.

In examples, responsive to receiving at least the remainder of the plurality of data records (e.g., in response to the third request 366), the remainder of the plurality of data records may be provided for output via the display associated with the client device 110. For example, the application may load the remainder of the plurality of data records into the data table or list asynchronously, such that the plurality of data records are viewable in the data table or list when a user scrolls, for example. In some embodiments, for example, prior to receiving at least the remainder of the plurality of data records, there may be additional operations performed on some or all of the remainder of the plurality of data records before the remainder of the plurality of data records are received.

In some embodiments, for example, each of the multiple database requests 360 may include a common timestamp, for identifying a common point in time for each database request, and to ensure that each database request is performed on the data records at the same point in time. In this regard, including a common timestamp in each of the multiple requests 360 may avoid data inconsistencies due to any changes that may occur in the database between the processing of each of the first request 362, second request 364 and third request 366. In other embodiments, for example, depending on the type of database being used, there may exist capabilities for capturing a point in time of a query, and a timestamp may not be explicitly required in the requests.

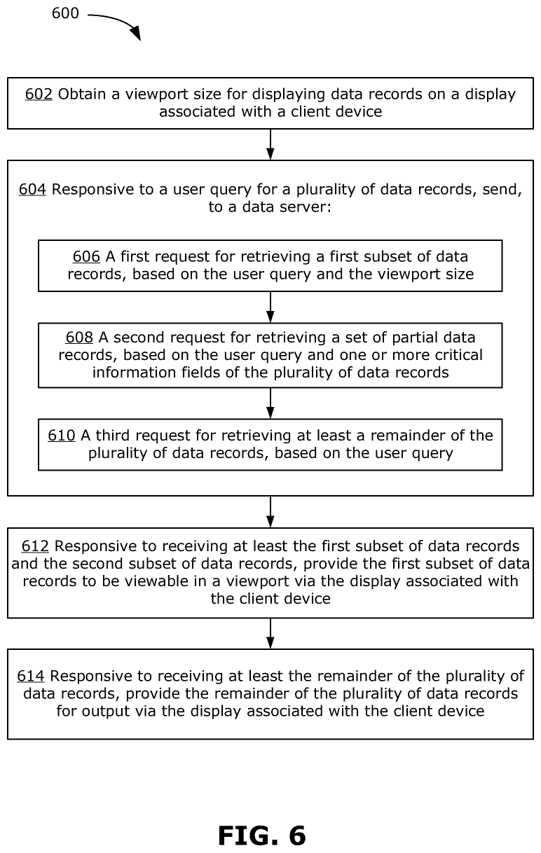

FIG. 6 is a flowchart of an example method 600, in accordance with examples of the present disclosure. The method 600 may be performed by the computing system 200. For example, a processing unit of a computing system (e.g., the processor 202 of the computing system 200 of FIG. 2) may execute instructions (e.g., instructions of the query splitting module 300) to cause the computing system to carry out the example method 600.

At an operation 602, a viewport size 325 for displaying data records on a display associated with a client device 110 may be obtained. In examples, the viewport size 325 may be determined based on one or more parameters of the display and/or applications running on the client device 110. For example, the viewport size 325 may be automatically determined by a web application running on the client device 110 at the time when a web page is rendered for the first time in the web application, among other possibilities. In other examples, the viewport size 325 may be determined based on viewport information obtained from the web application or based on system settings associated with the client device 110, among other possibilities.

At an operation 604, responsive to a user query 310 for a plurality of data records, a series of multiple requests 360 may be sent to a data server. For example, at an operation 606, a first request 362 for retrieving a first subset of data records may be generated based on the user query 310 and the viewport size 325 and sent to the data server. At an operation 608, a second request 364 for retrieving a set of partial data records may be generated based on the user query 310 and one or more critical information fields of the plurality of data records and sent to the data server. At an operation 610, a third request 366 for retrieving at least a remainder of the plurality of data records may be generated based on the user query 310 and sent to the data server.

At an operation 612, responsive to receiving at least the first subset of data records and the set of partial data records, the first subset of data records may be provided to be viewable in a viewport via the display associated with the client device 110.

At an operation 614, responsive to receiving at least the remainder of the plurality of data records, the remainder of the plurality of data records may be provided for output via the display associated with the client device 110.

Although the present disclosure describes methods and processes with operations (e.g., steps) in a certain order, one or more operations of the methods and processes may be omitted or altered as appropriate. One or more operations may take place in an order other than that in which they are described, as appropriate.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

The scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. Any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

Memory, as used herein, may refer to memory that is persistent (e.g. read-only-memory (ROM) or a disk), or memory that is volatile (e.g. random access memory (RAM)). The memory may be distributed, e.g. a same memory may be distributed over one or more servers or locations.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer-implemented method comprising:
obtaining a viewport size for displaying data records on a display associated with a client device;
responsive to a user query for a plurality of data records, sending, to a data server:
a first request for retrieving a first subset of data records, based on the user query and the viewport size;
a second request for retrieving a set of partial data records, based on the user query and one or more critical information fields of the plurality of data records; and
a third request for retrieving at least a remainder of the plurality of data records, based on the user query;
responsive to receiving at least the first subset of data records and the set of partial data records, providing the first subset of data records to be viewable in a viewport via the display associated with the client device; and
responsive to receiving at least the remainder of the plurality of data records, providing the remainder of the plurality of data records for output via the display associated with the client device.

2. The method of claim 1, wherein the third request is a request for retrieving a second subset of data records that is the remainder of the plurality of data records excluding the first subset of data records.

3. The method of claim 1, wherein the third request is a request for retrieving the plurality of data records including the first subset of data records.

4. The method of claim 1, further comprising:
prior to sending the first request:
determining a number of rows of the plurality of data records that are viewable in the viewport based on the viewport size and a row height; and
storing the determined number of rows in a local cache.

5. The method of claim 1, wherein the viewport is provided within an application, and the viewport size is obtained for a first page when the first page is rendered in the application.

6. The method of claim 1, wherein obtaining the viewport size comprises:
determining the viewport size based on viewport information, wherein the viewport information comprises at least one of:
dimensions of the display of the client device;
orientation of the display;
dimensions of a window of the application;
display settings of the application or the client device; or
accessibility settings of the application or the client device.

7. The method of claim 1, wherein obtaining the viewport size comprises determining the viewport size based on viewport information comprising dimensions of one or more user interface (UI) elements of the application.

8. The method of claim 1, wherein the viewport size includes a viewport width and a viewport height.

9. The method of claim 1, wherein the first request, the second request and the third request all include a common timestamp.

10. The method of claim 1, wherein the third request is sent after receiving at least the set of partial data records, and wherein the third request is generated based on information in the one or more critical information fields retrieved in the set of partial data records.

11. A non-transitory computer-readable medium storing instructions that, when executed by a processing unit of a computing system, cause the computing system to:
obtain a viewport size for displaying data records on a display associated with a client device;
responsive to a user query for a plurality of data records, send, to a data server:
a first request for retrieving a first subset of data records, based on the user query and the viewport size;
a second request for retrieving a set of partial data records, based on the user query and one or more critical information fields of the plurality of data records; and
a third request for retrieving at least a remainder of the plurality of data records, based on the user query;
responsive to receiving at least the first subset of data records and the set of partial data records, provide the first subset of data records to be viewable in a viewport via the display associated with the client device; and
responsive to receiving at least the remainder of the plurality of data records, provide the remainder of the plurality of data records for output via the display associated with the client device.

12. The computer-readable medium of claim 11, wherein the third request is a request for retrieving a second subset of data records that is the remainder of the plurality of data records excluding the first subset of data records.

13. The computer-readable medium of claim 11, wherein the third request is a request for retrieving the plurality of data records including the first subset of data records.

14. The computer-readable medium of claim 11, wherein the instructions, when executed, further cause the computing system to:
prior to sending the first request:
determine a number of rows of the plurality of data records that are viewable in the viewport based on the viewport size and a row height; and
store the determined number of rows in a local cache.

15. The computer-readable medium of claim 11, wherein the viewport is provided within an application, and the viewport size is obtained for a first page when the first page is rendered in the application.

16. The computer-readable medium of claim 11, wherein the instructions, when executed to obtain the viewport size, further cause the computing system to:
determine the viewport size based on viewport information, wherein the viewport information comprises at least one of:
dimensions of the display of the client device;
orientation of the display;
dimensions of a window of the application;
display settings of the application or the client device; or
accessibility settings of the application or the client device.

17. The computer-readable medium of claim 11, wherein the instructions, when executed to obtain the viewport size, further cause the computing system to:
determine the viewport size based on viewport information comprising dimensions of one or more user interface (UI) elements of the application.

18. The computer-readable medium of claim 11, wherein the viewport size includes a viewport width and a viewport height.

19. The computer-readable medium of claim 11, wherein the first request, the second request and the third request all include a common timestamp.

20. An apparatus comprising:
a processing unit communicatively coupled to a display device, the processing unit being configured to:
obtain a viewport size for displaying data records on the display device;
responsive to a user query for a plurality of data records, send, to a data server:
a first request for retrieving a first subset of data records, based on the user query and the viewport size;
a second request for retrieving a set of partial data records, based on the user query and one or more critical information fields of the plurality of data records; and
a third request for retrieving at least a remainder of the plurality of data records, based on the user query;
responsive to receiving at least the first subset of data records and the set of partial data records, provide the first subset of data records to be viewable in a viewport via the display device; and
responsive to receiving at least the remainder of the plurality of data records, provide the remainder of the plurality of data records for output via the display device.
